(19) United States
(12) Patent Application Publication
(10) Pub. No.: US 2019/0057329 A1
(43) Pub. Date: Feb. 21, 2019

(54) TRANSPORTATION MATCHMAKING METHOD AND QUERY

(71) Applicant: Lejla Zagorica, Arlington, VA (US)

(72) Inventor: Lejla Zagorica, Arlington, VA (US)

(21) Appl. No.: 16/105,937

(22) Filed: Aug. 20, 2018

Related U.S. Application Data
(60) Provisional application No. 62/547,630, filed on Aug. 18, 2017.

(51) Int. Cl. G06Q 10/02; G06F 17/30; G06Q 20/08

(52) U.S. Cl. CPC G06Q 10/02; G06Q 20/085; G06F 17/30554; G06F 17/30867

(57) ABSTRACT

A transportation matchmaking method may be useful for matching a user with a transportation service provider according to a series of preferences requested by the user. The transportation matchmaking method may include the steps of receiving a request for a transportation service from the user; presenting the user with a query of transportation service parameters such as music preferences and climate control preferences; receiving a response to the query substantiating the series of preferences from the user; selecting the transportation service provider from a service provider pool, the transportation service provider being selected to most closely match the response to the query; reserving a time slot for the transportation service provider; receiving a payment from the user; notifying the transportation service provider of the reservation; and notifying the user of the reservation.

### CROSS-REFERENCE TO RELATED APPLICATION(S)

The present application is related to and claims priority to U.S. Provisional Patent Application Number 62/547,630 filed Aug. 18, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of transportation services of existing art and more specifically relates to transportation matchmaking.

### Related Art

Ridesharing services have long provided economical means for reaching a destination. Ridesharing not only enables efficient transportation methods for those unable to provide their own transportation means, but also increases efficiency of traffic ways by reducing the amount of traffic. With the advent of automobiles, taxi cabs became increasingly popular in cities, offering affordable and expedient transportation to anybody. In more recent years, new technologies such as the internet and mobile devices have transformed the ways that ridesharing can be accomplished. Multiple corporate entities now offer a service of booking individual drivers over the internet in advance, no longer requiring a customer to flag down a cab in the street.

Unfortunately, current ridesharing services are still deficient in some areas. Often, a customer may be unsure what their ride experience will be like. Current services limit the communication between the customer and transportation provider and may not provide a wide variety of services and accommodations in an ever-growing market. A suitable solution is desired.

U.S. Pat. No. 9,547,309 to William Ross et al. relates to selecting vehicle type for providing transport. The described system of selecting vehicle type for providing transport includes a transport arrangement system operating to receive a transport request from a user, and to make a selection of a vehicle type for the user based at least in part on a set of criteria associated with the transport request or user information. For example, the determination of whether an autonomous vehicle is to be provided can be based at least in part on the destination specified with the transport request.

### SUMMARY OF THE INVENTION

In view of the foregoing disadvantages inherent in the known transportation matchmaking art, the present disclosure provides a novel transportation matchmaking method and query. The general purpose of the present disclosure, which will be described subsequently in greater detail, is to provide an efficient and effective transportation matchmaking method and query.

A transportation matchmaking method is disclosed herein. The transportation matchmaking method may be useful for matching a user with a transportation service provider according to a series of preferences requested by the user. The transportation matchmaking method may include the steps of receiving a request for a transportation service from the user; presenting the user with a query of transportation service parameters such as music preferences and climate control preferences; receiving a response to the query substantiating the series of preferences from the user; selecting the transportation service provider from a service provider pool, the transportation service provider being selected to most closely match the response to the query; reserving a time slot for the transportation service provider; receiving a payment from the user; notifying the transportation service provider of the reservation; and notifying the user of the reservation.

According to another embodiment, a software application is also disclosed herein. The software application is useful for executing the steps of the transportation matchmaking method via a computing device, such as a mobile device. The software application may include a graphical user interface. The graphical user interface may enable the user to perform each element of the transportation matchmaking method through interactions with the computing device. The software application may also include a memory which is able to store a user's service history and preferences. The software application may yet also include a user-profile able to identify the user's identity to the transportation service provider and display the user's preferences.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a transportation matchmaking method and query, constructed and operative according to the teachings of the present disclosure.

FIG. 1 is a flowchart of the transportation matchmaking method during an ‘in-use’ condition, according to an embodiment of the disclosure.

FIG. 2 is a perspective view of the query of the transportation matchmaking method of FIG. 1, according to an embodiment of the present disclosure.

FIG. 3 is a flowchart of the transportation matchmaking method of FIG. 1, according to an embodiment of the present disclosure.

FIG. 4 is a flowchart of the transportation matchmaking method of FIG. 1, according to an embodiment of the present disclosure.

FIG. 5 is a perspective view of the software application implementing the transportation matchmaking method of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a transportation matchmaking and more particularly to a transportation matchmaking method and query as used to improve the matching of a user with a transportation service provider according to a series of preferences.

Generally, the transportation matchmaking method and query herein provides a means for coordinating transportation services in a convenient manner which enables a user to order rides to a desired location while also choosing a driver which matches several of the user's described preference(s). In a preferred embodiment, the method is implemented via a software application able to function via a computing device, and particularly a mobile device. The method includes advantageous features, incentives, and rewards for both drivers and passengers when compared to prior ride-share methodologies. The method enables users to select a destination and request specific amenities such as charging stations, radios, climate control, language settings, and more. This system may help eliminate concerns of being matched to a driver incapable of meeting the customer's needs and preferences.

The transportation matchmaking method may include an algorithm for determining which driver best matches a user's set of preferences. In a preferred embodiment, the user is asked to answer a query including a list of selectable parameters for driver preference, such as vehicle type, climate control type, and music type. For example, a user may choose the following preferences: sedan, air conditioning, and country music. In this situation, the method would select a driver having these preferences available as services. If no driver was available, the method may select a driver most closely matching these preferences. The user may have alternative options besides matchmaking via the query. For example, the user may search through an array of driver profiles and select one manually. Alternatively, the user may select a driver from a history of drivers whom the user has obtained services from in the past.

In use via the software application, the user may select their destination and upon the request, multiple profiles representing drivers may appear on the screen. The user may then choose a driver or examine driver profile. Preferably, a rating system may appear with the driver profile so that a user may see other user's ratings and experiences. The user may then be able to select amenities or simply a desired driver before purchasing the ride. In some embodiments, a user may be able to select multiple preferences simultaneously and then be automatically matched with one or more drivers best matching the user's preference. These preferences may be offered via a query.

Selectable preferences and additional amenities may include language preferences, map and navigation access, car type selection (i.e., SUV, sedan, number of seats, etc.), vehicle model, amenities (climate control, music preference, phone chargers), multiple user pickups, price comparisons for competitors, an emergency panic button feature, notifications of nearby attractions with map illustrations, and driver rating submissions. Other user preferences besides the ones listed may be incorporated in the query and the driver profiles.

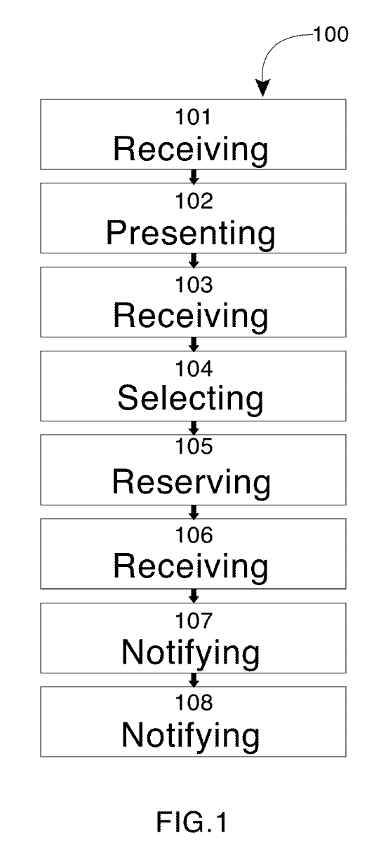

Referring now more specifically to the drawings by numerals of reference, there is shown in FIGS. 1-4, various views of a transportation matchmaking method 100.

FIG. 1 is a flow diagram illustrating a method for matching a user with a transportation service provider according to a series of preferences, according to an embodiment of the present disclosure. Transportation matchmaking method 100 may be useful for matching a user with a transportation service provider according to a series of preferences requested by the user. The transportation matchmaking method may comprise the steps of: step one 101, receiving a request for a transportation service; step two 102, presenting the user with a query of transportation service parameters; step three 103, receiving a response to the query, the query being configured to obtain the series of preferences from the user; step four 104, selecting the transportation service provider from a service provider pool, the transportation service provider most closely matching the response to the query; step five 105, reserving a time slot for the transportation service provider; step six 106, receiving a payment from the user; step seven 107, notifying the transportation service provider of the reservation; and step eight 108, notifying the user of the reservation.

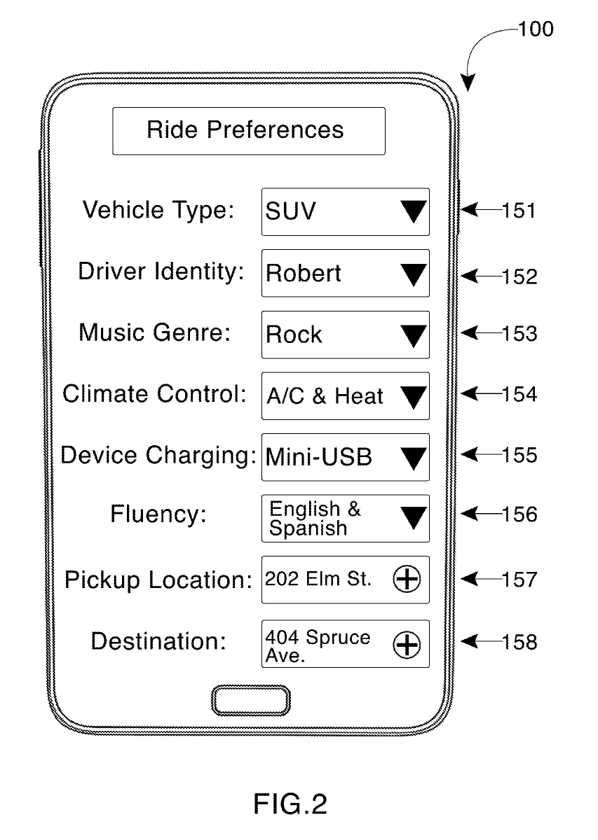

FIG. 2 shows the transportation matchmaking method 100 of FIG. 1, according to an embodiment of the present disclosure. The query of step 102 (FIG. 1) may include requesting a vehicle type preference 151, requesting a driver identity preference 152, requesting a musical genre preference 153, requesting a climate control setting preference 154, requesting a device charging availability preference 155, requesting a driver language fluency preference 156, requesting a pickup location 157, requesting a destination 158, or any combination thereof.

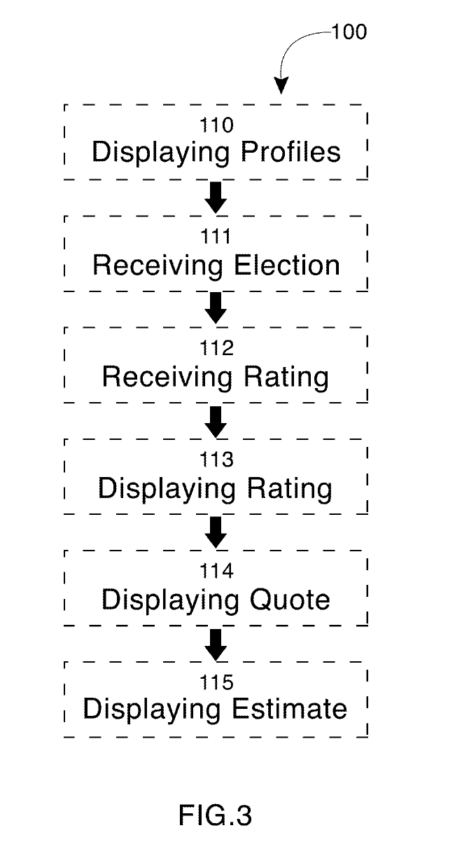

FIG. 3 is a flow diagram illustrating a method for matching a user with a transportation service provider according to a series of preferences, according to an embodiment of the present disclosure. The transportation matchmaking method 100 may further comprise step nine 109, displaying a digital map, the map being an interactive satellite map configured to illustrate and recommend routes; step ten 110, displaying a plurality of profiles corresponding to a plurality of transportation service candidates; step eleven 111, receiving an election from the user, the election selecting one from the plurality of plurality of profiles as the transportation service provider; step twelve 112, receiving at least one rating, the rating being submitted by the user, the rating representing to a perceived performance of the transportation service provider; step thirteen 113, displaying the at least one rating on one of the plurality of profiles corresponding to the transportation service provider; step fourteen 114, displaying a quote representing the cost of the user's transportation service as requested by the user; and step fifteen 115, displaying an estimate representing the cost of the user's transportation service as quoted by a competitive entity.

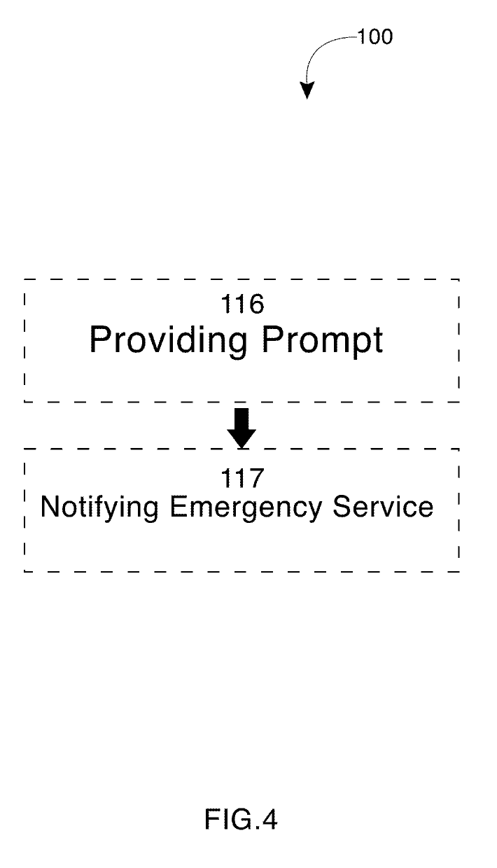

FIG. 4 is a flow diagram illustrating a method for matching a user with a transportation service provider according to a series of preferences, according to an embodiment of the present disclosure. The transportation matchmaking method 100 may further comprise step sixteen 116, providing an emergency-prompt configured to be selected by the user during an emergency; and step seventeen 117, notifying an emergency service in response to the selection of the emergency-prompt by the user; wherein the emergency service is a law enforcement agency; and wherein the emergency service is an emergency dispatcher.

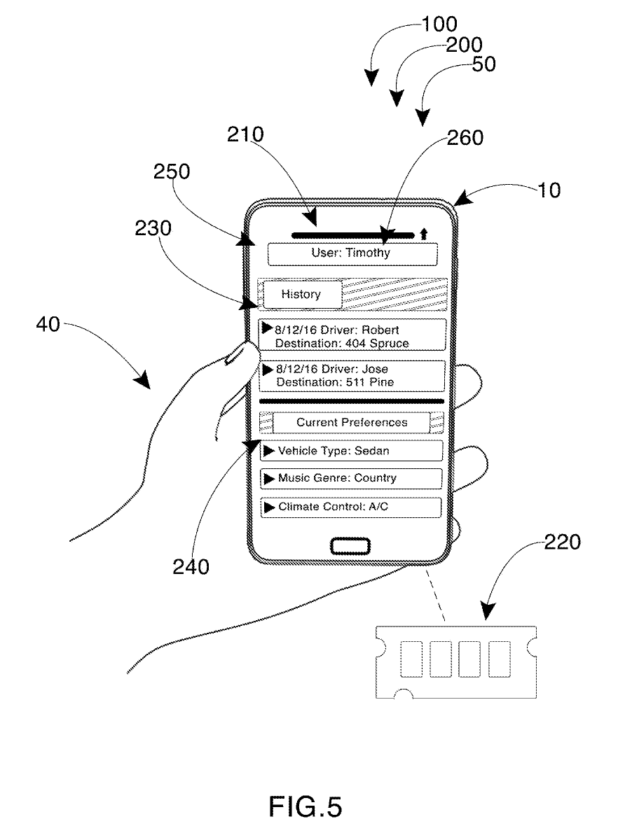

FIG. 5 is a perspective view of a software application 200 configured to implement the transportation matchmaking method 100 of FIG. 1 via a computing device 10 during an in-use condition 50, according to an embodiment of the present disclosure. The software application may comprise graphical user interface 210 configured to enable user 40 to perform each element of transportation matchmaking method 100 and memory 220 configured to store service history 230 and preferences 240 corresponding to user 40. Software application 200 may further comprise user-profile 250 configured to identify identity 260 of user 40 to transportation service provider 20 and display preferences 240 of user 40.

Upon reading this specification, it should be appreciated that, under appropriate circumstances, considering such issues as user preferences, design preference, structural requirements, marketing preferences, cost, available materials, technological advances, etc., other methodological and software arrangements such as, for example, additional steps, additional software features and implementations, etc., may be sufficient.

It should be noted that steps 109-117 are optional steps and may not be implemented in all cases. Optional steps of method of use 100 are illustrated using dotted lines in FIG. 3 and FIG. 4 so as to distinguish them from the other steps of method of use 100. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for matching a user with a transportation service provider according to a series of preferences, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A transportation matchmaking method for matching a user with a transportation service provider according to a series of preferences requested by the user, the transportation matchmaking method comprising the steps of:
receiving a request for a transportation service;
presenting the user with a query of transportation service parameters;
receiving a response to the query, the query being configured to obtain the series of preferences from the user;
selecting the transportation service provider from a service provider pool, the transportation service provider most closely matching the response to the query;
reserving a time slot for the transportation service provider;
receiving a payment from the user;
notifying the transportation service provider of the reservation; and
notifying the user of the reservation.

2. The transportation matchmaking method of claim 1, wherein the query includes requesting a vehicle type preference.

3. The transportation matchmaking method of claim 1, wherein the query includes requesting a driver identity preference.

4. The transportation matchmaking method of claim 1, wherein the query includes requesting a musical genre preference.

5. The transportation matchmaking method of claim 1, wherein the query includes requesting a climate control setting preference.

6. The transportation matchmaking method of claim 1, wherein the query includes requesting a device charging availability preference.

7. The transportation matchmaking method of claim 1, wherein the query includes requesting a driver language fluency preference.

8. The transportation matchmaking method of claim 1, wherein the query includes requesting a pickup location.

9. The transportation matchmaking method of claim 1, wherein the query includes requesting a destination.

10. The transportation matchmaking method of claim 1, further comprising the step of displaying a digital map, the map being an interactive satellite map configured to illustrate and recommend routes.

11. The transportation matchmaking method of claim 1, further comprising the steps of:
displaying a plurality of profiles corresponding to a plurality of transportation service candidates; and
receiving an election from the user, the election selecting one from the plurality of plurality of profiles as the transportation service provider.

12. The transportation matchmaking method of claim 11, further comprising the steps of:
receiving at least one rating, the rating being submitted by the user, the rating representing to a perceived performance of the transportation service provider; and
displaying the at least one rating on one of the plurality of profiles corresponding to the transportation service provider.

13. The transportation matchmaking method of claim 1, further comprising the steps of:
providing an emergency-prompt configured to be selected by the user during an emergency;
notifying an emergency service in response to the selection of the emergency-prompt by the user.

14. The transportation matchmaking method of claim 13, wherein the emergency service is a law enforcement agency.

15. The transportation matchmaking method of claim 13, wherein the emergency service is an emergency dispatcher.

16. The transportation matchmaking method of claim 1, further comprising the steps of:
displaying a quote representing the cost of the user's transportation service as requested by the user; and
displaying an estimate representing the cost of the user's transportation service as quoted by a competitive entity.

17. A transportation matchmaking method having selection of transportation service preferences comprising the steps of:
receiving a request for a transportation service;
presenting the user with a query of transportation service parameters;
receiving a response to the query, the query being configured to obtain the series of preferences from the user;
selecting the transportation service provider from a service provider pool, the transportation service provider most closely matching the response to the query;
reserving a time slot for the transportation service provider;
receiving a payment from the user;
notifying the transportation service provider of the reservation;
notifying the user of the reservation;
displaying a digital map, the map being an interactive satellite map configured to illustrate and recommend routes;
displaying a plurality of profiles corresponding to a plurality of transportation service candidates;
receiving an election from the user, the election selecting one from the plurality of plurality of profiles as the transportation service provider;
receiving at least one rating, the rating being submitted by the user, the rating representing to a perceived performance of the transportation service provider;
displaying the at least one rating on one of the plurality of profiles corresponding to the transportation service provider;
providing an emergency-prompt configured to be selected by the user during an emergency;
notifying an emergency service in response to the selection of the emergency-prompt by the user;
displaying a quote representing the cost of the user's transportation service as requested by the user; and
displaying an estimate representing the cost of the user's transportation service as quoted by a competitive entity;
wherein the query includes requesting a vehicle type preference;
wherein the query further includes requesting a driver identity preference;
wherein the query further includes requesting a musical genre preference;
wherein the query further includes requesting a climate control setting preference;
wherein the query further includes requesting a device charging availability preference;
wherein the query further includes requesting a driver language fluency preference;
wherein the query further includes requesting a pickup location; and
wherein the query further includes requesting a destination.

18. A software application configured to implement the transportation matchmaking method of claim 1 via a computing device, the software application comprising:
a graphical user interface configured to enable the user to perform each element of the transportation matchmaking method; and
a memory configured to store a user's service history and preferences.

19. The software application of claim 19, further comprising a user-profile configured to identify the user's identity to the transportation service provider and display the user's preferences.
